(19) United States
(12) Patent Application Publication
(10) Pub. No.: US 2026/0261027 A1
(43) Pub. Date: Sep. 3, 2026

(54) PHASE SHIFTER AND BASE STATION ANTENNA

(71) Applicant: Huawei Technologies Co., Ltd., Shenzhen (CN)

(72) Inventors: Xinming Liu, Xi'an (CN); Jiaxu Li, Xi'an (CN); Peifeng Hu, Xi'an (CN); Wei Kang, Beijing (CN); Yi Yang, Xi'an (CN)

(21) Appl. No.: 19/659,158

(22) Filed: Apr. 27, 2026

Related U.S. Application Data
(63) Continuation of application No. PCT/CN2024/126972, filed on Oct. 24, 2024.

(30) Foreign Application Priority Data
Oct. 28, 2023 (CN) 202311427442.X

(51) Int. Cl. H01P 1/18; H01Q 3/32

(52) U.S. Cl. CPC H01P 1/184; H01Q 3/32

(57) ABSTRACT

Embodiments of this application provide a phase shifter and a base station antenna. The phase shifter includes a fixing frame, a phase-shifting stripline, and a sliding dielectric. The fixing frame includes a guide rail. The phase-shifting stripline is fixed on the guide rail. The sliding dielectric is slidably connected to the guide rail, and the sliding dielectric is separated from the phase-shifting stripline by the guide rail. The guide rail can guide movement of the sliding dielectric relative to the phase-shifting stripline, helping improve smoothness of the movement of the sliding dielectric relative to the phase-shifting stripline. Because the sliding dielectric is separated from the phase-shifting stripline by the guide rail, and during the movement of the sliding dielectric relative to the phase-shifting stripline, the sliding dielectric does not rub against the phase-shifting stripline.

### CROSS-REFERENCE TO RELATED APPLICATIONS

This application is a continuation of International Application No. PCT/CN2024/126972, filed on October 24, 2024, which claims priority to Chinese Patent Application No. 202311427442.X, filed on October 28, 2023. The disclosures of the aforementioned applications are hereby incorporated by reference in their entireties.

### TECHNICAL FIELD

This application relates to the field of communication technologies, and in particular, to a phase shifter and a base station antenna.

### BACKGROUND

With the continuous development of mobile communication networks, users have increasingly higher requirements for communication performance. In a mobile communication network, a phase shifter is configured to adjust phase distribution of each radiating element in an antenna, to change radiation coverage and communication quality of the antenna. In an existing phase shifter, a phase-shifting stripline is fixed by a fixing frame, and a sliding dielectric of the phase shifter slides on the fixing frame. During sliding, the sliding dielectric encounters large sliding resistance with both the phase-shifting stripline and the fixing frame, affecting smoothness of the sliding dielectric during sliding.

### SUMMARY

Embodiments of this application provide a phase shifter and a base station antenna, to improve smoothness of a sliding dielectric during sliding.

According to a first aspect, an embodiment of this application provides a phase shifter. The phase shifter includes: a fixing frame, provided with a guide rail; a phase-shifting stripline, fixed on the guide rail; and a sliding dielectric, slidably connected to the guide rail, where the sliding dielectric is separated from the phase-shifting stripline by the guide rail.

The sliding dielectric is slidably connected to the guide rail, and the sliding dielectric is separated from the phase-shifting stripline by the guide rail. The guide rail can guide movement of the sliding dielectric relative to the phase-shifting stripline, helping improve smoothness of the movement of the sliding dielectric relative to the phase-shifting stripline.

Because the sliding dielectric is separated from the phase-shifting stripline by the guide rail, the sliding dielectric is not in contact with the phase-shifting stripline, and during the movement of the sliding dielectric relative to the phase-shifting stripline, the sliding dielectric does not rub against the phase-shifting stripline, thereby reducing resistance during the movement of the sliding dielectric relative to the phase-shifting stripline, further improving smoothness of the movement of the sliding dielectric relative to the phase-shifting stripline, also reducing pulling force for driving the sliding dielectric to move relative to the phase-shifting stripline, and helping reduce a requirement for a driving member that drives the sliding dielectric to move relative to the phase-shifting stripline.

According to the first aspect, in a possible implementation of this application, the sliding dielectric includes a first dielectric sheet and a second dielectric sheet that are disposed opposite to each other, the guide rail is located between the first dielectric sheet and the second dielectric sheet, the phase-shifting stripline is located between the first dielectric sheet and the second dielectric sheet, a side that is of the guide rail and that faces the first dielectric sheet is slidably connected to the first dielectric sheet, a side that is of the guide rail and that faces the second dielectric sheet is slidably connected to the second dielectric sheet, the first dielectric sheet is separated from the phase-shifting stripline by the guide rail, and the second dielectric sheet is separated from the phase-shifting stripline by the guide rail.

In this possible implementation, when the first dielectric sheet slides along the guide rail relative to the phase-shifting stripline, because the first dielectric sheet is separated from the phase-shifting stripline by the guide rail, during sliding, the first dielectric sheet does not rub against the phase-shifting stripline, thereby reducing resistance of the first dielectric sheet during sliding, and further reducing a pulling force requirement for the driving member.

Because the guide rail is located between the first dielectric sheet and the second dielectric sheet, this is equivalent to disposing the guide rail inside the sliding dielectric. In comparison with providing the fixing frame outside the first dielectric sheet and the second dielectric sheet, in comparison with a case in which dielectric sheets have a same height in a third direction in a conventional technology, the phase shifter provided in this application has a smaller height in a direction perpendicular to a sliding direction of the first dielectric sheet or the second dielectric sheet, helping reduce a height of the guide rail.

When the second dielectric sheet slides along the guide rail relative to the phase-shifting stripline, because the second dielectric sheet is separated from the phase-shifting stripline by the guide rail, during sliding, the second dielectric sheet does not rub against the phase-shifting stripline, thereby reducing resistance of the second dielectric sheet during sliding, and further reducing a pulling force requirement for the driving member.

According to the first aspect, in a possible implementation of this application, a first sliding slot is provided on a side that is of the first dielectric sheet and that faces the phase-shifting stripline, a second sliding slot is provided on a side that is of the second dielectric sheet and that faces the phase-shifting stripline, a side that is of the guide rail and that faces the first dielectric sheet is slidably connected to the first sliding slot, and a side that is of the guide rail and that faces the second dielectric sheet is slidably connected to the second sliding slot.

In this possible implementation, the first sliding slot is provided on the first dielectric sheet, and the guide rail is partially accommodated in the first sliding slot of the first dielectric sheet, so that the guide rail is slidably connected to the first sliding slot of the first dielectric sheet. This structure is simple, helping reduce manufacturing costs of the phase shifter.

According to the first aspect, in a possible implementation of this application, the phase shifter further includes a first rolling ball, a third sliding slot is provided on a side that is of the guide rail and that faces the first dielectric sheet, the first rolling ball is partially accommodated in the first sliding slot, the first rolling ball is partially accommodated in the third sliding slot, and the first rolling ball is capable of rolling relative to the guide rail.

In this possible implementation, because the guide rail is connected to the first dielectric sheet through the first rolling ball, the first rolling ball is capable of rolling along the first sliding slot relative to the guide rail, and sliding friction between the guide rail and the first dielectric sheet is changed to rolling friction. This helps further reduce resistance during sliding of the first dielectric sheet relative to the phase-shifting stripline, and further improve smoothness of movement of the first dielectric sheet relative to the phase-shifting stripline.

According to the first aspect, in a possible implementation of this application, the phase shifter further includes a second rolling ball, a fourth sliding slot is provided on a side that is of the guide rail and that faces the second dielectric sheet, the second rolling ball is partially accommodated in the second sliding slot, the second rolling ball is partially accommodated in the fourth sliding slot, and the second rolling ball is capable of rolling relative to the guide rail.

In this possible implementation, because the guide rail is connected to the second dielectric sheet through the second rolling ball, the second rolling ball can roll along the second sliding slot relative to the guide rail, and sliding friction between the guide rail and the second dielectric sheet is changed to rolling friction. This helps further reduce resistance during sliding of the second dielectric sheet relative to the phase-shifting stripline, and further improve smoothness of movement of the second dielectric sheet relative to the phase-shifting stripline.

According to the first aspect, in a possible implementation of this application, the phase shifter further includes a shielding cavity, the fixing frame, the phase-shifting stripline, the first dielectric sheet, and the second dielectric sheet are all accommodated in the shielding cavity, and the guide rail is fixed relative to the shielding cavity.

In this possible implementation, the shielding cavity has electromagnetic shielding properties, may be used as a grounding structure of the phase-shifting stripline, and further provides shielding against external signal interference, to ensure transmission of an electrical signal of the phase-shifting stripline. In other words, the shielding cavity is used as a shielding cavity of the phase-shifting stripline.

According to the first aspect, in a possible implementation of this application, a first sliding portion is disposed on an inner wall that is of the shielding cavity and that faces the first dielectric sheet, a second sliding portion is disposed on a side that is of the first dielectric sheet and that is opposite to the phase-shifting stripline, and the second sliding portion of the first dielectric sheet is slidably connected to the first sliding portion.

In this possible implementation, the side that is of the first dielectric sheet and that faces the phase-shifting stripline is slidably connected to the guide rail, and the side that is of the first dielectric sheet and that is opposite to the phase-shifting stripline is slidably connected to the inner wall of the shielding cavity, that is, sliding of the first dielectric sheet relative to the phase-shifting stripline is guided and limited by both opposite sides of the first dielectric sheet, thereby further improving smoothness and stability of sliding of the first dielectric sheet relative to the phase-shifting stripline.

According to the first aspect, in a possible implementation of this application, the phase shifter further includes a third rolling ball, a fifth sliding slot is provided on the first sliding portion, a sixth sliding slot is provided on the second sliding portion, the third rolling ball is partially accommodated in the fifth sliding slot, the second rolling ball is partially accommodated in the sixth sliding slot, and the third rolling ball is capable of rolling relative to the guide rail.

In this possible implementation, because the first sliding portion is slidably connected to the second sliding portion through the third rolling ball, the third rolling ball is capable of rolling relative to the guide rail. During the movement of the first dielectric sheet relative to the phase-shifting stripline, the third rolling ball rolls relative to the guide rail, to change static/sliding friction into rolling friction, thereby reducing resistance during sliding of the first dielectric sheet relative to the phase-shifting stripline, and helping improve smoothness of sliding of the first dielectric sheet relative to the phase-shifting stripline.

According to the first aspect, in a possible implementation of this application, a third sliding portion is disposed on an inner wall that is of the shielding cavity and that faces the second dielectric sheet, a fourth sliding portion is disposed on a side that is of the second dielectric sheet and that is opposite to the phase-shifting stripline, and the fourth sliding portion of the second dielectric sheet is slidably connected to the third sliding portion.

In this possible implementation, the side that is of the second dielectric sheet and that faces the phase-shifting stripline is slidably connected to the guide rail, and the side that is of the second dielectric sheet and that is opposite to the phase-shifting stripline is slidably connected to the inner wall of the shielding cavity, that is, sliding of the second dielectric sheet relative to the phase-shifting stripline is guided and limited by both opposite sides of the second dielectric sheet, thereby further improving smoothness and stability of sliding of the second dielectric sheet relative to the phase-shifting stripline.

According to the first aspect, in a possible implementation of this application, the phase shifter further includes a fourth rolling ball, a seventh sliding slot is provided on the third sliding portion, an eighth sliding slot is provided on the fourth sliding portion, the fourth rolling ball is partially accommodated in the seventh sliding slot, the fourth rolling ball is partially accommodated in the eighth sliding slot, and the fourth rolling ball is capable of rolling relative to the guide rail.

In this possible implementation, because the third sliding portion is slidably connected to the fourth sliding portion through the fourth rolling ball, the fourth rolling ball is capable of rolling relative to the guide rail. During the movement of the second dielectric sheet relative to the phase-shifting stripline, the fourth rolling ball rolls relative to the guide rail, to change static/sliding friction into rolling friction, thereby reducing resistance during sliding of the second dielectric sheet relative to the phase-shifting stripline, and helping improve smoothness of sliding of the second dielectric sheet relative to the phase-shifting stripline.

According to the first aspect, in a possible implementation of this application, the phase shifter further includes a first support, and one end of the guide rail is fixedly connected to the first support.

In this possible implementation, the first support is configured to support the guide rail, so as to improve reliability of the guide rail.

According to a second aspect, an embodiment of this application further provides a base station antenna. The base station antenna includes radiating elements, and the phase shifter according to the first aspect, and the phase shifter is electrically connected to the base station antenna.

### BRIEF DESCRIPTION OF THE DRAWINGS

FIG. 1 is a diagram of a structure of an antenna system according to an embodiment of this application;

FIG. 2 is a diagram of an internal architecture of a base station antenna according to an embodiment of this application;

FIG. 3 is a three-dimensional diagram of a phase shifter according to a first embodiment of this application;

FIG. 4 is a three-dimensional exploded diagram of the phase shifter shown in FIG. 3 with a shielding cavity removed;

FIG. 5 is a three-dimensional assembly diagram of a sliding dielectric and a fixing frame;

FIG. 6 is a three-dimensional diagram of a first dielectric sheet;

FIG. 7 is a three-dimensional assembly diagram of a first dielectric sheet and a fixing frame;

FIG. 8 is a three-dimensional diagram of a partial structure of a phase shifter according to a second embodiment of this application;

FIG. 9 is a three-dimensional exploded diagram of a fixing frame, a phase-shifting stripline, and a sliding dielectric according to the second embodiment of this application;

FIG. 10 is a three-dimensional assembly diagram of a fixing frame and a phase-shifting stripline according to the second embodiment of this application;

FIG. 11 is a three-dimensional diagram of a first dielectric sheet according to the second embodiment of this application;

FIG. 12 is a three-dimensional assembly diagram of a partial structure of a phase shifter according to a third embodiment of this application;

FIG. 13 is a three-dimensional exploded perspective diagram of the phase shifter shown in FIG. 12;

FIG. 14 is a side view of the phase shifter according to the third embodiment;

FIG. 15 is a three-dimensional diagram of a partial structure of a shielding cavity; and

FIG. 16 is a diagram of a side that is of a first dielectric sheet and that is opposite to a phase-shifting stripline according to the third embodiment.

### DETAILED DESCRIPTION OF ILLUSTRATIVE EMBODIMENTS

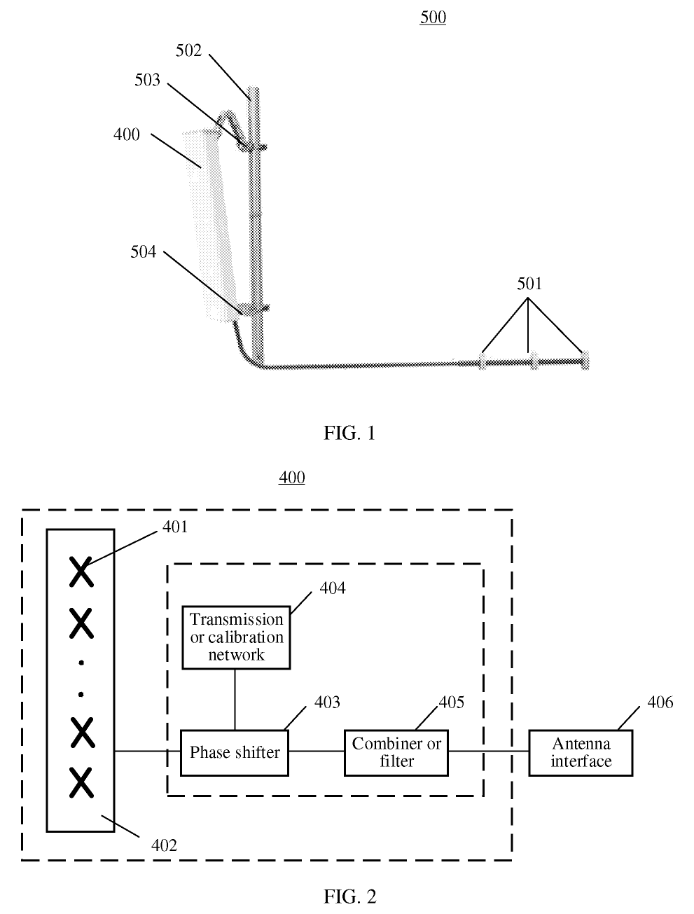

An embodiment of this application provides a base station, including a building baseband unit (building baseband unit, BBU), a remote radio unit (remote radio unit, RRU), and an antenna system. FIG. 1 is a diagram of a structure of an antenna system according to an embodiment of this application. The remote radio unit is connected between the building baseband unit and the antenna system 500. There may be a plurality of antenna systems 500, and there may also be a plurality of remote radio units of a same quantity as the antenna systems 500. Each antenna system 500 cooperates with one remote radio unit, and the plurality of antenna systems 500 each are connected to one building baseband unit through a corresponding remote radio unit, to implement functions of receiving and sending radio signals.

Refer to the diagram of the structure of the antenna system 500 shown in FIG. 1. The antenna system 500 includes a base station antenna 400, a pole 502, an antenna support 503, a connector sealing member 504, and a grounding apparatus 501. The pole 502 is fixed relative to the ground, and the antenna support 503 is connected between the base station antenna 400 and the pole 502, so that the base station antenna 400 is fixedly connected to the pole 502. In some embodiments, the antenna support 503 may alternatively be configured as an adjustable support that is configured to adjust an orientation and an angle of the base station antenna 400 relative to the pole 502, to cooperate with a signal transmitting angle of the base station antenna 400, and ensure that a signal emitted by the antenna system 500 can form a preset downtilt angle with the ground. The base station in this application may be disposed in any public place or cell, to implement a signal coverage function in an area corresponding to the base station.

The base station antenna 400 is an array antenna, and the base station antenna 400 is further electrically connected to the grounding apparatus 501, to implement a grounding function of the base station antenna 400. One end that is of the grounding apparatus 501 and that is far away from the base station antenna 400 may be further fixedly connected to the pole 502, to implement a grounding function through the pole 502. It may be understood that the grounding apparatus 501 may alternatively be directly fixed on the ground, to ensure a reliable grounding function of the base station antenna 400. The base station antenna 400 is usually accommodated in a sealed enclosure (radome). In terms of mechanical performance, the enclosure needs to have sufficient rigidity and strength and capabilities such as anti-fouling and waterproofing, to protect internal components of the base station antenna 400 from an external environment. In terms of electrical performance, the enclosure needs to have a good electromagnetic wave penetration characteristic, to ensure signal sending and receiving functions of the base station antenna 400. The connector sealing member 504 may be further disposed between the grounding apparatus 501 and the enclosure of the base station antenna 400. When the grounding apparatus 501 is led out from the base station antenna 400, a sealed connection between the grounding apparatus 501 and the enclosure of the base station antenna 400 can be implemented through the connector sealing member 504, to implement sealed protection for all components inside the enclosure of the base station antenna 400.

FIG. 2 is a diagram of an internal architecture of a base station antenna according to an embodiment of this application. In this application, a radiating element 401, a metal reflection panel 402, and a phase shifter 403 are provided inside an enclosure of the base station antenna 400. The radiating element 401 is located on one side of the metal reflection panel 402, and form at least one independent radiating array with the metal reflection panel 402. The radiating element 401 is an antenna element, configured to transmit or receive a radio wave. Frequencies of a plurality of radiating elements 401 in an independent radiating array may be the same or may be different, to correspond to radio wave sending and receiving in different frequency bands. When the metal reflection panel 402 is located on one side of the radiating element 401, the metal reflection panel 402 may reflect radio signals, and concentrate the radio signals on the radiating element 401, to enhance the radio signals received by the radiating element 401. The metal reflection panel 402 is further configured to reflect a radio signal at the radiating element 401 and transmit the radio signal to the outside, to enhance strength of the signal emitted by the radiating element 401. The metal reflection panel 402 is further configured to block or shield a radio signal from the other side (that is, a reverse direction) of the radiating element 401, to prevent the radio signal from the other side from interfering with the radiating element 401.

It may be understood that the phase shifter 403 in the base station antenna 400 is a phase shifter in this application. The phase shifter 403 is electrically connected to the radiating elements 401, and one side that is of the phase shifter 403 and that is opposite to the radiating elements 401 is further connected to an antenna interface 406, and is connected to a building baseband unit (not shown in the figure) of the base station through the antenna interface 406. The building baseband unit of the base station may be configured to generate a signal. After phase allocation is performed on the signal by the phase shifter 403, the signal is transferred to the radiating element 401 for external transmission. Alternatively, the building baseband unit is configured to receive a radio signal transmitted by the radiating element 401, and the radio signal is obtained through phase processing by the phase shifter 403. The phase shifter 403 in this application is configured to perform phase adjustment on a radio signal, to change a downtilt angle of a radio signal beam, thereby optimizing a communication network. Functional components such as a transmission or calibration network 404 and a combiner or filter 405 may be further disposed in the base station antenna 400, and are respectively configured to perform operations such as calibrating a radio signal and adjusting an amplitude of a radio signal. The phase shifter 403, the calibration network 404, the combiner or filter 405 may form a phase-shifting network. The phase-shifting network may be physical phase-shifting or dielectric phase-shifting.

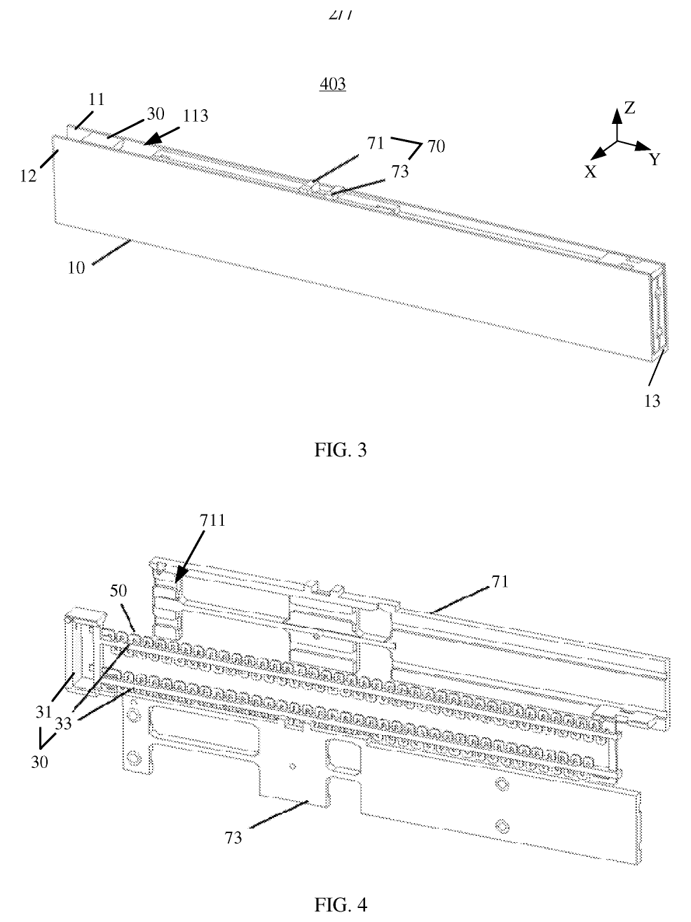

FIG. 3 is a three-dimensional diagram of a phase shifter 403 according to a first embodiment of this application. FIG. 4 is a three-dimensional exploded diagram of the phase shifter shown in FIG. 3 with a shielding cavity removed. The phase shifter 403 may include a shielding cavity 10, a fixing frame 30, a phase-shifting stripline 50, and a sliding dielectric 70. The fixing frame 30, the phase-shifting stripline 50, and the sliding dielectric 70 are all accommodated in the shielding cavity 10. The phase-shifting stripline 50 is fixed on the fixing frame 30. The sliding dielectric 70 may slide relative to the phase-shifting stripline 50, to change an electrical length of the phase-shifting stripline 50 to adjust a phase of the phase shifter 403. In the phase shifter 403 in this application, the phase-shifting stripline 50 may be configured to implement a function of a power divider. To be specific, the sliding dielectric 70 slides relative to the power divider formed by the phase-shifting stripline 50, to change a phase output of the phase shifter 403. It may be understood that, in some other embodiments, the phase-shifting stripline 50 provided in this application may alternatively be used as a coupler, an electronic regulator, a filter, or the like, and is used in the base station in this application, to implement functions such as microwave radio signal transmission and/or phase adjustment.

The shielding cavity 10 has electromagnetic shielding properties, may be used as a grounding structure of the phase-shifting stripline 50, and provides shielding against external signal interference, to ensure transmission of an electrical signal of the phase-shifting stripline 50. In other words, the shielding cavity 10 is used as a shielding cavity of the phase-shifting stripline 50. In some implementations of this application, the shielding cavity 10 is approximately of a cuboid structure, and the shielding cavity 10 includes a first side wall 11, a second side wall 12, and a third side wall 13. The first side wall 11 and the second side wall 12 are disposed opposite to each other in a first direction. A length direction of the first side wall 11 and a length direction of the second side wall 12 define a second direction. The third side wall 13 is connected between the first side wall 11 and the second side wall 12. The first side wall 11 and the second side wall 12 form an opening 113 at one end away from the third side wall 13. The opening 113 and the third side wall 13 are disposed opposite to each other in a third direction. The first direction may be an X direction shown in FIG. 3, the second direction may be a Y direction shown in FIG. 3, and the third direction may be a Z direction shown in FIG. 3. In this implementation, any two of the first direction, the second direction, and the third direction are perpendicular to each other. It may be understood that any two of the first direction, the second direction, and the third direction are not limited to being perpendicular to each other in this application, provided that the first direction is different from the second direction, the second direction is different from the third direction, and the first direction is different from the third direction. It may be understood that a structure of the shielding cavity 10 is not limited in this application. For example, the shielding cavity 10 may alternatively be a circular shielding cavity, or the shielding cavity 10 may be a closed shielding cavity.

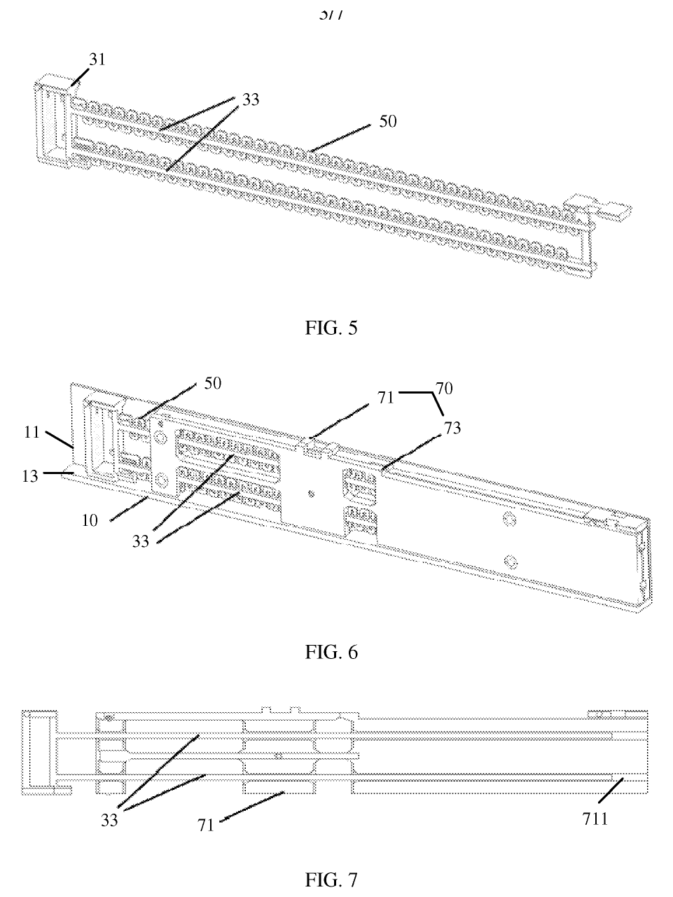

The fixing frame 30 is accommodated in the shielding cavity 10, and is fixed relative to the shielding cavity 10. The fixing frame 30 is made of a non-metal material. The fixing frame 30 is located between the first side wall 11 and the second side wall 12 in the first direction. FIG. 5 is a three-dimensional assembly diagram of the sliding dielectric and the fixing frame. The fixing frame 30 includes a first support 31 and a guide rail 33. The first support 31 may be fixedly connected to the shielding cavity 10. For example, the first support 31 is fixedly connected to at least one of the first side wall 11, the second side wall 12, and the third side wall 13. The first support 31 is configured to support the guide rail 33. One end or two ends of the guide rail 33 are fixedly connected to the first support 31. The guide rail 33 is configured to support the phase-shifting stripline 50, and is slidably connected to the sliding dielectric 70. The first support 31 and the guide rail 33 may be integrally disposed, or the first support 31 and the guide rail 33 may be separately disposed. It may be understood that the first support 31 may be omitted, one end of the guide rail 33 is directly fixed on the shielding cavity 10, and the guide rail 33 is fixed relative to the shielding cavity 10.

The phase-shifting stripline 50 is fixed on the guide rail 33. The sliding dielectric 70 is slidably connected to the guide rail 33, and the sliding dielectric 70 is separated from the phase-shifting stripline 50 by the guide rail 33. The guide rail 33 can guide movement of the sliding dielectric 70 relative to the phase-shifting stripline 50, helping improve smoothness of the movement of the sliding dielectric 70 relative to the phase-shifting stripline 50. Because the sliding dielectric 70 is separated from the phase-shifting stripline 50 by the guide rail 33, the sliding dielectric 70 is not in contact with the phase-shifting stripline 50, and during the movement of the sliding dielectric 70 relative to the phase-shifting stripline 50, the sliding dielectric 70 does not rub against the phase-shifting stripline 50, thereby reducing resistance during the movement of the sliding dielectric 70 relative to the phase-shifting stripline 50, further improving smoothness of the movement of the sliding dielectric 70 relative to the phase-shifting stripline 50, also reducing pulling force for driving the sliding dielectric 70 to move relative to the phase-shifting stripline 50, and helping reduce a requirement for a driving member that drives the sliding dielectric 70 to move relative to the phase-shifting stripline 50.

In this embodiment, the phase-shifting stripline 50 passes through the guide rail 33 and extends along the guide rail 33. The phase-shifting stripline 50 may be a serpentine line or a straight line. The phase-shifting stripline 50 may be in a form of a microstrip, a suspended stripline, or the like.

Refer to FIG. 3, FIG. 4, and FIG. 6. FIG. 6 is a three-dimensional diagram of a first dielectric sheet. The sliding dielectric 70 includes a first dielectric sheet 71 and a second dielectric sheet 73 that are disposed opposite to each other in the first direction. The first dielectric sheet 71 is slidably connected to a side that is of the guide rail 33 and that faces the first side wall 11. The first dielectric sheet 71 is located between the first side wall 11 and the phase-shifting stripline 50. The guide rail 33 is partially located between the first dielectric sheet 71 and the phase-shifting stripline 50. To be specific, the first dielectric sheet 71 is separated from the phase-shifting stripline 50 by the guide rail 33, and the first dielectric sheet 71 is not in contact with the phase-shifting stripline 50. The first dielectric sheet 71 may be connected to a driving member. For example, the driving member may be connected to the first dielectric sheet 71 through the opening 113. The driving member is configured to drive the first dielectric sheet 71 to move relative to the phase-shifting stripline 50. The driving member may be a driving apparatus, for example, a motor, a cylinder, or a hydraulic cylinder.

When the first dielectric sheet 71 slides along the guide rail 33 relative to the phase-shifting stripline 50, because the first dielectric sheet 71 is separated from the phase-shifting stripline 50 by the guide rail 33, during sliding, the first dielectric sheet 71 does not rub against the phase-shifting stripline 50, thereby reducing resistance of the first dielectric sheet 71 during sliding, and further reducing a pulling force requirement for the driving member.

In some implementations of this application, refer to FIG. 7. FIG. 7 is a three-dimensional assembly diagram of the first dielectric sheet and the fixing frame. A first sliding slot 711 is provided on a side that is of the first dielectric sheet 71 and that faces the phase-shifting stripline 50, and a side that is of the guide rail 33 and that faces the first dielectric sheet 71 partially extends into the first sliding slot 711 of the first dielectric sheet 71 and is slidably connected to the first sliding slot 711. The first sliding slot 711 is provided on the first dielectric sheet 71, and the guide rail 33 is partially accommodated in the first sliding slot 711 of the first dielectric sheet 71, so that the guide rail 33 is slidably connected to the first sliding slot 711 of the first dielectric sheet 71. This structure is simple, helping reduce manufacturing costs of the phase shifter 403.

The second dielectric sheet 73 and the first dielectric sheet 71 are disposed opposite to each other. The second dielectric sheet 73 is slidably connected to a side that is of the guide rail 33 and that faces the second side wall 12. The second dielectric sheet 73 is located between the second side wall 12 and the phase-shifting stripline 50. The guide rail 33 is partially located between the second dielectric sheet 73 and the phase-shifting stripline 50. To be specific, the second dielectric sheet 73 is separated from the phase-shifting stripline 50 by the guide rail 33, and the second dielectric sheet 73 is not in contact with the phase-shifting stripline 50. The second dielectric sheet 73 may be connected to a driving member. For example, the driving member may be connected to the second dielectric sheet 73 through the opening 113. The driving member is configured to drive the second dielectric sheet 73 to move relative to the phase-shifting stripline 50. The driving member may be a driving apparatus, for example, a motor, a cylinder, or a hydraulic cylinder.

When the second dielectric sheet 73 slides along the guide rail 33 relative to the phase-shifting stripline 50, because the second dielectric sheet 73 is separated from the phase-shifting stripline 50 by the guide rail 33, during sliding, the second dielectric sheet 73 does not rub against the phase-shifting stripline 50, thereby reducing resistance of the second dielectric sheet 73 during sliding, and further reducing a pulling force requirement for the driving member.

In some implementations of this application, a second sliding slot is provided on a side that is of the second dielectric sheet 73 and that faces the phase-shifting stripline 50, and a side that is of the guide rail 33 and that faces the second dielectric sheet 73 partially extends into the second sliding slot of the second dielectric sheet 73 and is slidably connected to the second sliding slot of the second dielectric sheet 73. The second sliding slot is provided on the second dielectric sheet 73, and the guide rail 33 is partially accommodated in the second sliding slot of the second dielectric sheet 73, so that the guide rail 33 is slidably connected to the second sliding slot of the second dielectric sheet 73. This structure is simple, helping reduce manufacturing costs of the phase shifter 403.

In addition, because the guide rail 33 is located between the first dielectric sheet 71 and the second dielectric sheet 73, this is equivalent to disposing the guide rail 33 inside the sliding dielectric 70. In comparison with a case in which dielectric sheets have a same height in the third direction in a conventional technology, the guide rail 33 has a smaller height in the third direction, helping reduce the height of the guide rail 33 in the third direction.

In some implementations of this application, there are two guide rails 33, the two guide rails 33 are spaced apart in the third direction, there are at least two first sliding slots 711 on the first dielectric sheet 71, there are at least two second sliding slots on the second dielectric sheet 73, and each guide rail 33 is slidably connected to the first sliding slot 711 at a corresponding position on the first dielectric sheet 71 and the second sliding slot 731 at a corresponding position on the second dielectric sheet 73. Because there are two guide rails 33, stability of sliding of the first dielectric sheet 71 and the second dielectric sheet 73 relative to the phase-shifting stripline 50 is improved. It may be understood that a quantity of guide rails 33 is not limited in this application. For example, there may be at least one guide rail 33, there may be at least one first sliding slot 711 on the first dielectric sheet 71, and there may be at least one second sliding slot on the second dielectric sheet 73.

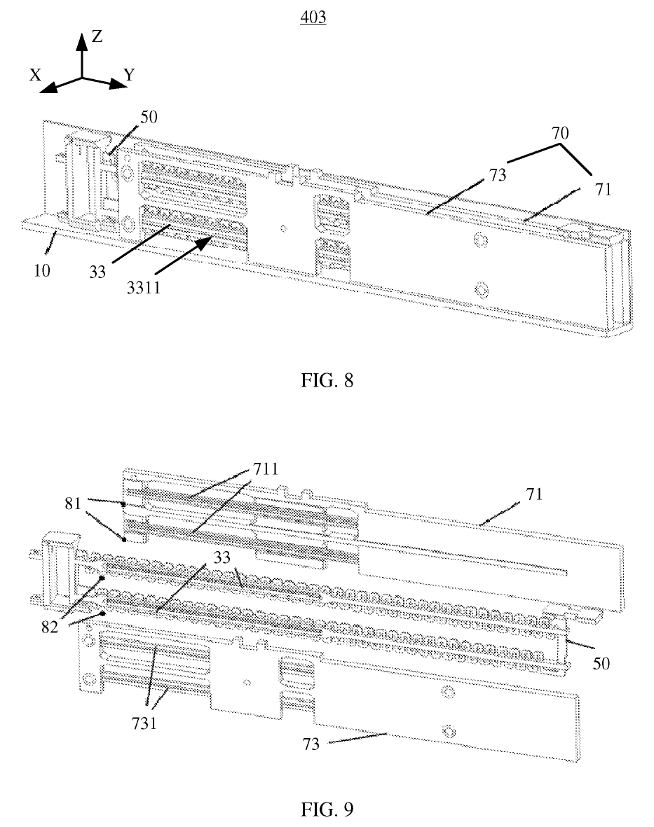

FIG. 8 is a three-dimensional diagram of a partial structure of a phase shifter according to a second embodiment of this application. FIG. 9 is a three-dimensional exploded diagram of a fixing frame, a phase-shifting stripline, and a sliding dielectric according to the second embodiment of this application. The phase shifter 403 provided in the second embodiment has roughly the same structure as the phase shifter provided in the first embodiment. A difference at least lies in that the phase shifter 403 provided in the second embodiment further includes a first rolling ball 81 and a second rolling ball 82, a side that is of a guide rail 33 and that faces a first dielectric sheet 71 is connected to the first dielectric sheet 71 through the first rolling ball 81, a side that is of the guide rail 33 and that faces a second dielectric sheet 73 is connected to the second dielectric sheet 73 through the second rolling ball 82, the first rolling ball 81 can roll relative to the guide rail 33, and the second rolling ball 82 can roll relative to the guide rail 33.

Because the side that is of the guide rail 33 and that faces the first dielectric sheet 71 is connected to a first sliding slot 711 through the first rolling ball 81, the first rolling ball 81 can roll along the first sliding slot 711 relative to the guide rail 33, and sliding friction between the guide rail 33 and the first dielectric sheet 71 is changed to rolling friction. This helps further reduce resistance during sliding of the first dielectric sheet 71 relative to the phase-shifting stripline 50, and further improve smoothness of movement of the first dielectric sheet 71 relative to the phase-shifting stripline 50.

Because the side that is of the guide rail 33 and that faces the second dielectric sheet 73 is connected to a second sliding slot through the second rolling ball 82, the second rolling ball 82 can roll along the second sliding slot 731 relative to the guide rail 33, and sliding friction between the guide rail 33 and the second dielectric sheet 73 is changed to rolling friction. This helps further reduce resistance during sliding of the second dielectric sheet 73 relative to the phase-shifting stripline 50, and further improve smoothness of movement of the second dielectric sheet 73 relative to the phase-shifting stripline 50.

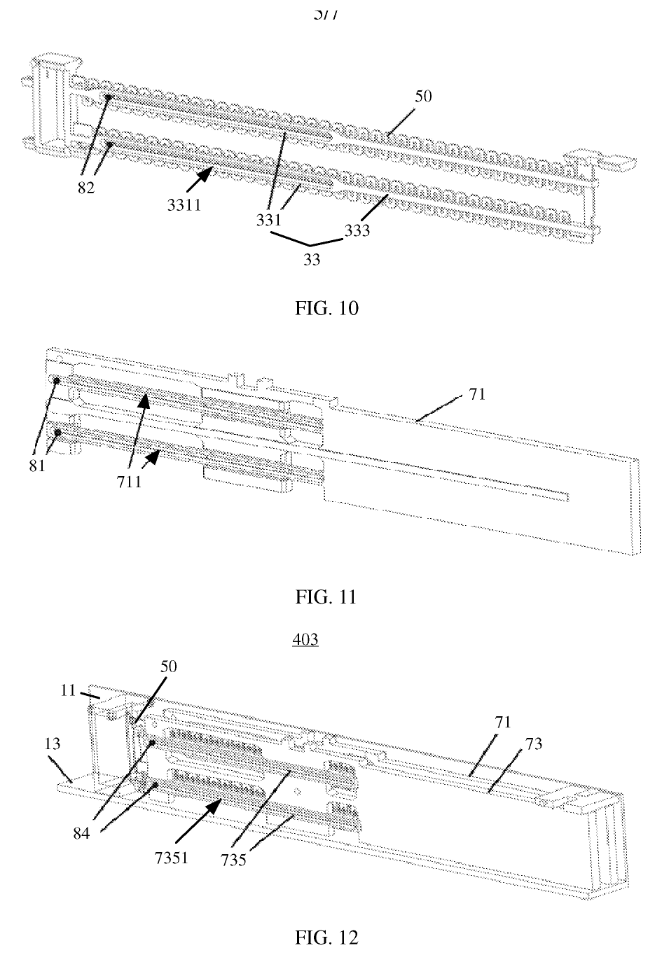

FIG. 10 is a three-dimensional assembly diagram of the fixing frame and the phase-shifting stripline according to the second embodiment of this application. The guide rail 33 includes a sliding section 331 and a connecting section 333 that are fixedly connected along an extension direction of the guide rail 33. In a second direction, a third sliding slot is provided on a side that is of the sliding section 331 and that faces the first dielectric sheet 71. A fourth sliding slot 3311 is provided on a side that is of the sliding section 331 and that faces the second dielectric sheet 73. A width of the sliding section 331 in a third direction is greater than a width of the connecting section 333 in the third direction, to improve strength of the guide rail 33, thereby improving reliability of the guide rail 33. It may be understood that the width of the sliding section 331 of the guide rail 33 in the third direction may be less than or equal to the width of the connecting section 333 in the third direction.

FIG. 11 is a three-dimensional diagram of the first dielectric sheet according to the second embodiment of this application. FIG. 11 shows a structure of the first dielectric sheet 71 as an example. Through at least one first rolling ball 81, the first sliding slot 711 of the first dielectric sheet 71 is slidably connected to the third sliding slot on the side that is of the guide rail 33 and that faces the first dielectric sheet 71. The first rolling ball 81 is partially accommodated in the first sliding slot 711 of the first dielectric sheet 71, and is partially accommodated in the third sliding slot of the guide rail 33. During sliding of the first dielectric sheet 71 relative to the phase-shifting stripline 50, the first rolling ball 81 between the first dielectric sheet 71 and the guide rail 33 rolls in the first sliding slot 711 and the third sliding slot.

Each first rolling ball 81 is partially accommodated in a corresponding first sliding slot 711 and a corresponding third sliding slot, and movement of the first rolling ball 81 is guided and limited by both the first sliding slot 711 and the third sliding slot, thereby reducing a possibility that the first rolling ball 81 is disengaged from the first dielectric sheet 71 and the guide rail 33, and helping improve stability of movement of the first dielectric sheet 71 relative to the phase-shifting stripline 50.

The second rolling ball 82 is partially accommodated in the second sliding slot of the second dielectric sheet 73, and is partially accommodated in the fourth sliding slot 3311 on the side that is of the guide rail 33 and that faces the second dielectric sheet 73. During sliding of the second dielectric sheet 73 relative to the phase-shifting stripline 50, the second rolling ball 82 between the second dielectric sheet 73 and the guide rail 33 rolls in the second sliding slot of the second dielectric sheet 73 and in the fourth sliding slot 3311 on the side that is of the guide rail 33 and that faces the second dielectric sheet 73.

Each second rolling ball 82 is partially accommodated in a corresponding second sliding slot and a corresponding fourth sliding slot 3311, and movement of the second rolling ball 82 is guided and limited by both the second sliding slot and the fourth sliding slot 3311, thereby reducing a possibility that the second rolling ball 82 is disengaged from the second dielectric sheet 73 and the guide rail 33, and helping improve stability of the movement of the first dielectric sheet 71 relative to the phase-shifting stripline 50.

It may be understood that the third sliding slot on the guide rail 33 may be omitted, and the first rolling ball 81 is rollably disposed in the first sliding slot 711, or the first rolling ball 81 may be rollably disposed on the guide rail 33.

It may be understood that the first sliding slot 711 on the first dielectric sheet 71 may be omitted, and the first rolling ball 81 is rollably disposed in the third sliding slot on the side that is of the guide rail 33 and that faces the first dielectric sheet 71, or the first rolling ball 81 may be rollably disposed on a side that is of the first dielectric sheet 71 and that faces the guide rail 33.

It may be understood that the fourth sliding slot 3311 on the guide rail 33 may be omitted, and the second rolling ball 82 is rollably disposed in the second sliding slot, or the second rolling ball 82 may be rollably disposed on the guide rail 33.

It may be understood that the second sliding slot on the second dielectric sheet 73 may be omitted, and the second rolling ball 82 is rollably disposed in the fourth sliding slot 3311 on the side that is of the guide rail 33 and that faces the second dielectric sheet 73, or the second rolling ball 82 may be rollably disposed on a side that is of the second dielectric sheet 73 and that faces the guide rail 33.

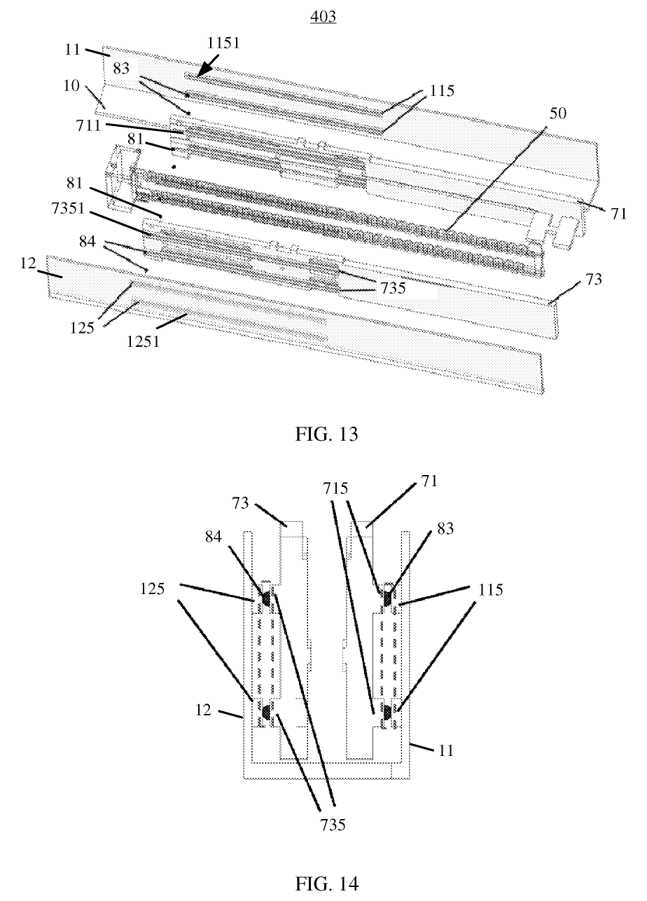

FIG. 12 is a three-dimensional assembly diagram of a partial structure of a phase shifter according to a third embodiment of this application. FIG. 13 is a three-dimensional exploded perspective diagram of the phase shifter shown in FIG. 12. FIG. 14 is a side view of the phase shifter according to the third embodiment. A structure of the phase shifter 403 provided in the third embodiment has roughly the same structure as the phase shifter provided in the second embodiment. A difference at least lies in that, in the phase shifter 403 provided in the third embodiment, an inner wall of a shielding cavity 10 is slidably connected to a side that is of a first dielectric sheet 71 and that is opposite to a phase-shifting stripline 50, and the inner wall of the shielding cavity 10 is slidably connected to a side that is of a second dielectric sheet 73 and that is opposite to the phase-shifting stripline 50.

A side that is of the first dielectric sheet 71 and that faces the phase-shifting stripline 50 is slidably connected to a guide rail 33, and the side that is of the first dielectric sheet 71 and that is opposite to the phase-shifting stripline 50 is slidably connected to the inner wall of the shielding cavity 10, that is, sliding of the first dielectric sheet 71 relative to the phase-shifting stripline 50 is guided and limited by both opposite sides of the first dielectric sheet 71 in a second direction, thereby further improving smoothness and stability of sliding of the first dielectric sheet 71 relative to the phase-shifting stripline 50.

A side that is of the second dielectric sheet 73 and that faces the phase-shifting stripline 50 is slidably connected to the guide rail 33, and the side that is of the second dielectric sheet 73 and that is opposite to the phase-shifting stripline 50 is slidably connected to the inner wall of the shielding cavity 10, that is, sliding of the second dielectric sheet 73 relative to the phase-shifting stripline 50 is guided and limited by both opposite sides of the second dielectric sheet 73 in the second direction, thereby further improving smoothness and stability of sliding of the second dielectric sheet 73 relative to the phase-shifting stripline 50.

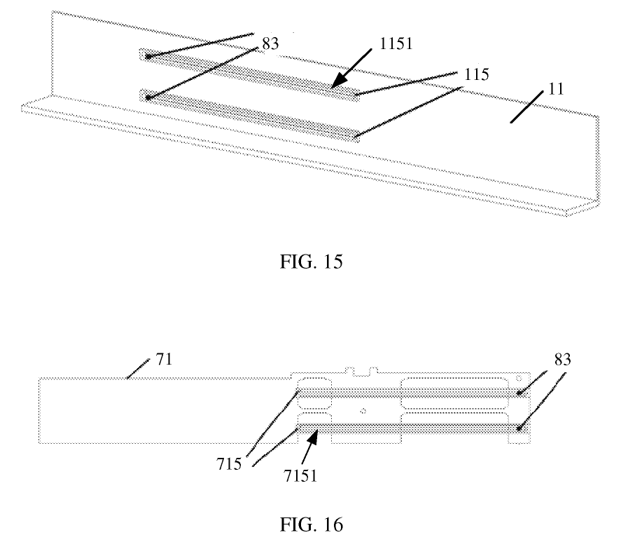

FIG. 15 is a three-dimensional diagram of a partial structure of the shielding cavity. FIG. 16 is a diagram of the side that is of the first dielectric sheet and that is opposite to the phase-shifting stripline according to the third embodiment. A first sliding portion 115 is disposed on an inner wall that is of a first side wall 11 of the shielding cavity 10 and that faces the first dielectric sheet 71, a second sliding portion 715 is disposed on a side that is of the first dielectric sheet 71 and that is opposite to the phase-shifting stripline 50, and the first sliding portion 115 of the first side wall 11 is slidably connected to the second sliding portion 715 of the first dielectric sheet 71. The phase shifter 403 further includes a third rolling ball 83, and the first sliding portion 115 of the first side wall 11 is slidably connected to the second sliding portion 715 of the first dielectric sheet 71 through the third rolling ball 83. The third rolling ball 83 can roll relative to the guide rail 33.

Because the first sliding portion 115 is slidably connected to the second sliding portion 715 through the third rolling ball 83, the third rolling ball 83 can roll relative to the guide rail 33. During movement of the first dielectric sheet 71 relative to the phase-shifting stripline 50, the third rolling ball 83 rolls relative to the guide rail 33, and sliding friction is changed to rolling friction, thereby reducing resistance during sliding of the first dielectric sheet 71 relative to the phase-shifting stripline 50, and helping improve smoothness of sliding of the first dielectric sheet 71 relative to the phase-shifting stripline 50.

In this embodiment, both the first sliding portion 115 and the second sliding portion 715 are waist-shaped guide rails, a fifth sliding slot 1151 (as shown in FIG. 15) is provided on each first sliding portion 115, a sixth sliding slot 7151 (as shown in FIG. 16) is provided on each second sliding portion 715, and extension directions of the fifth sliding slot 1151 and the sixth sliding slot 7151 are the same as an extension direction of the guide rail 33. Each third rolling ball 83 is partially accommodated in a corresponding fifth sliding slot 1151, and each third rolling ball 83 is partially accommodated in a corresponding sixth sliding slot 7151.

Because each third rolling ball 83 is partially accommodated in the corresponding fifth sliding slot 1151 and the corresponding sixth sliding slot 7151, movement of the third rolling ball 83 is guided and limited by both the fifth sliding slot 1151 and the corresponding sixth sliding slot 7151, thereby reducing a possibility that the third rolling ball 83 is disengaged from the first dielectric sheet 71 and the guide rail 33, and helping improve stability of movement of the first dielectric sheet 71 relative to the phase-shifting stripline 50.

A third sliding portion 125 is disposed on an inner wall that is of a second side wall 12 of the shielding cavity 10 and that faces the second dielectric sheet 73, a fourth sliding portion 735 is disposed on a side that is of the second dielectric sheet 73 and that is opposite to the phase-shifting stripline 50, and the third sliding portion 125 of the second side wall 12 is slidably connected to the fourth sliding portion 735 of the second dielectric sheet 73. The phase shifter 403 further includes a fourth rolling ball 84, and the third sliding portion 125 of the second side wall 12 is slidably connected to the fourth sliding portion 735 of the second dielectric sheet 73 through the fourth rolling ball 84. The fourth rolling ball 84 can roll relative to the guide rail 33.

Because the third sliding portion 125 is slidably connected to the fourth sliding portion 735 through the fourth rolling ball 84, the fourth rolling ball 84 can roll relative to the guide rail 33. During movement of the second dielectric sheet 73 relative to the phase-shifting stripline 50, the fourth rolling ball 84 rolls relative to the guide rail 33, and sliding friction is changed to rolling friction, thereby reducing resistance during sliding of the second dielectric sheet 73 relative to the phase-shifting stripline 50, and helping improve smoothness of sliding of the second dielectric sheet 73 relative to the phase-shifting stripline 50.

In this embodiment, both the third sliding portion 125 and the fourth sliding portion 735 are waist-shaped guide rails, a seventh sliding slot 1251 is provided on each third sliding portion 125, an eighth sliding slot 7351 is provided on each fourth sliding portion 735, and extensions direction of the seventh sliding slot 1251 and the eighth sliding slot 7351 are the same as an extension direction of the guide rail 33. Each fourth rolling ball 84 is partially accommodated in a corresponding seventh sliding slot 1251, and each fourth rolling ball 84 is partially accommodated in a corresponding eighth sliding slot 7351.

Because each fourth rolling ball 84 is partially accommodated in the corresponding seventh sliding slot 1251 and the corresponding eighth sliding slot 7351, movement of the fourth rolling ball 84 is guided and limited by both the seventh sliding slot 1251 and the corresponding eighth sliding slot 7351, thereby reducing a possibility that the fourth rolling ball 84 is disengaged from the second dielectric sheet 73 and the guide rail 33, and helping improve stability of movement of the second dielectric sheet 73 relative to the phase-shifting stripline 50.

It may be understood that, in some possible implementations, the third rolling ball 83 may be omitted, one of the first sliding portion 115 and the second sliding portion 715 may be a sliding slot, the other of the first sliding portion 115 and the second sliding portion 715 may be a sliding rail, and the sliding rail is slidably connected to the sliding slot.

It may be understood that, in some possible implementations, the fourth rolling ball 84 may be omitted, one of the third sliding portion 125 and the fourth sliding portion 735 may be a sliding slot, the other of the third sliding portion 125 and the fourth sliding portion 735 may be a sliding rail, and the sliding rail is slidably connected to the sliding slot.

It may be understood that a manner in which the shielding cavity 10 is slidably connected to the sliding dielectric 70 is not limited in this application.

It may be understood that the first embodiment to the third embodiment of this application may be used in combination with each other without conflict or inconsistency.

It should be understood that the expressions such as "include" and "may include" that can be used in this application represent existence of disclosed functions, operations, or constituent elements, and are not limited to one or more additional functions, operations, or constituent elements. In this application, the terms such as "include" and/or "have" can be construed as representing a particular feature, quantity, operation, constituent element, component, or a combination thereof, but cannot be construed as excluding existence or addition possibility of one or more other features, quantities, operations, constituent elements, components, or combinations thereof.

In addition, in this application, the expression "and/or" includes any and all combinations of listed associated words. For example, the expression "A and/or B" may include A, may include B, or may include both A and B.

In this application, expressions including ordinal numbers such as "first" and "second" may modify elements. However, the elements are not limited by the expressions. For example, the expressions do not limit an order and/or importance of the elements. The expression is used only to distinguish one element from another. For example, first user equipment and second user equipment indicate different user equipment, although both the first user equipment and the second user equipment are user equipment. Similarly, without departing from the scope of this application, a first element may be referred to as a second element, and similarly, a second element may also be referred to as a first element.

When a component "is connected to" or "accesses" another component, it should be understood that the component not only is directly connected to or accesses the another component, but there may be another component between the component and the another component. In addition, when a component "is directly connected to" or "directly accesses" another component, it should be understood that there is no component between the component and the another component.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A phase shifter, wherein the phase shifter comprises:
a fixing frame, provided with a guide rail;
a phase-shifting stripline, fixed on the guide rail;
a sliding dielectric, wherein the sliding dielectric is slidably connected to the guide rail, and the sliding dielectric is separated from the phase-shifting stripline by the guide rail.

2. The phase shifter according to claim 1, wherein the sliding dielectric comprises a first dielectric sheet and a second dielectric sheet that are disposed opposite to each other, the guide rail is located between the first dielectric sheet and the second dielectric sheet, and the phase-shifting stripline is located between the first dielectric sheet and the second dielectric sheet; and
a side that is of the guide rail and that faces the first dielectric sheet is slidably connected to the first dielectric sheet, a side that is of the guide rail and that faces the second dielectric sheet is slidably connected to the second dielectric sheet, the first dielectric sheet is separated from the phase-shifting stripline by the guide rail, and the second dielectric sheet is separated from the phase-shifting stripline by the guide rail.

3. The phase shifter according to claim 2, wherein a first sliding slot is provided on a side that is of the first dielectric sheet and that faces the phase-shifting stripline, a second sliding slot is provided on a side that is of the second dielectric sheet and that faces the phase-shifting stripline, the side that is of the guide rail and that faces the first dielectric sheet is slidably connected to the first sliding slot, and the side that is of the guide rail and that faces the second dielectric sheet is slidably connected to the second sliding slot.

4. The phase shifter according to claim 3, wherein the phase shifter further comprises a first rolling ball, a third sliding slot is provided on the side that is of the guide rail and that faces the first dielectric sheet, the first rolling ball is partially accommodated in the first sliding slot, the first rolling ball is partially accommodated in the third sliding slot, and the first rolling ball is capable of rolling relative to the guide rail.

5. The phase shifter according to claim 3, wherein the phase shifter further comprises a second rolling ball, a fourth sliding slot is provided on the side that is of the guide rail and that faces the second dielectric sheet, the second rolling ball is partially accommodated in the second sliding slot, the second rolling ball is partially accommodated in the fourth sliding slot, and the second rolling ball is capable of rolling relative to the guide rail.

6. The phase shifter according to claim 2, wherein the phase shifter further comprises a shielding cavity, the fixing frame, the phase-shifting stripline, the first dielectric sheet, and the second dielectric sheet are all accommodated in the shielding cavity, and the guide rail is fixed relative to the shielding cavity.

7. The phase shifter according to claim 6, wherein a first sliding portion is disposed on an inner wall that is of the shielding cavity and that faces the first dielectric sheet, a second sliding portion is disposed on a side that is of the first dielectric sheet and that is opposite to the phase-shifting stripline, and the second sliding portion of the first dielectric sheet is slidably connected to the first sliding portion.

8. The phase shifter according to claim 7, wherein the phase shifter further comprises a third rolling ball, a fifth sliding slot is provided on the first sliding portion, a sixth sliding slot is provided on the second sliding portion, the third rolling ball is partially accommodated in the fifth sliding slot, the third rolling ball is partially accommodated in the sixth sliding slot, and the third rolling ball is capable of rolling relative to the guide rail.

9. The phase shifter according to claim 6, wherein a third sliding portion is provided on an inner wall that is of the shielding cavity and that faces the second dielectric sheet, a fourth sliding portion is provided on a side that is of the second dielectric sheet and that is opposite to the phase-shifting stripline, and the fourth sliding portion of the second dielectric sheet is slidably connected to the third sliding portion.

10. The phase shifter according to claim 9, wherein the phase shifter further comprises a fourth rolling ball, a seventh sliding slot is provided on the third sliding portion, an eighth sliding slot is provided on the fourth sliding portion, the fourth rolling ball is partially accommodated in the seventh sliding slot, the fourth rolling ball is partially accommodated in the eighth sliding slot, and the fourth rolling ball is capable of rolling relative to the guide rail.

11. The phase shifter according to claim 1, wherein the fixing frame further comprises a first support, and one end of the guide rail is fixedly connected to the first support.

12. A base station antenna, wherein the base station antenna comprises a radiating element, and the phase shifter, and the phase shifter is electrically connected to the radiating element;
wherein the phase shifter comprises:
a fixing frame, provided with a guide rail;
a phase-shifting stripline, fixed on the guide rail;
a sliding dielectric, wherein the sliding dielectric is slidably connected to the guide rail, and the sliding dielectric is separated from the phase-shifting stripline by the guide rail.

13. The base station antenna according to claim 12, wherein the sliding dielectric comprises a first dielectric sheet and a second dielectric sheet that are disposed opposite to each other, the guide rail is located between the first dielectric sheet and the second dielectric sheet, and the phase-shifting stripline is located between the first dielectric sheet and the second dielectric sheet; and
a side that is of the guide rail and that faces the first dielectric sheet is slidably connected to the first dielectric sheet, a side that is of the guide rail and that faces the second dielectric sheet is slidably connected to the second dielectric sheet, the first dielectric sheet is separated from the phase-shifting stripline by the guide rail, and the second dielectric sheet is separated from the phase-shifting stripline by the guide rail.

14. The base station antenna according to claim 13, wherein a first sliding slot is provided on a side that is of the first dielectric sheet and that faces the phase-shifting stripline, a second sliding slot is provided on a side that is of the second dielectric sheet and that faces the phase-shifting stripline, the side that is of the guide rail and that faces the first dielectric sheet is slidably connected to the first sliding slot, and the side that is of the guide rail and that faces the second dielectric sheet is slidably connected to the second sliding slot.

15. The base station antenna according to claim 14, wherein the phase shifter further comprises a first rolling ball, a third sliding slot is provided on the side that is of the guide rail and that faces the first dielectric sheet, the first rolling ball is partially accommodated in the first sliding slot, the first rolling ball is partially accommodated in the third sliding slot, and the first rolling ball is capable of rolling relative to the guide rail.

16. The base station antenna according to claim 14, wherein the phase shifter further comprises a second rolling ball, a fourth sliding slot is provided on the side that is of the guide rail and that faces the second dielectric sheet, the second rolling ball is partially accommodated in the second sliding slot, the second rolling ball is partially accommodated in the fourth sliding slot, and the second rolling ball is capable of rolling relative to the guide rail.

17. The base station antenna according to claim 13, wherein the phase shifter further comprises a shielding cavity, the fixing frame, the phase-shifting stripline, the first dielectric sheet, and the second dielectric sheet are all accommodated in the shielding cavity, and the guide rail is fixed relative to the shielding cavity.

18. The base station antenna according to claim 17, wherein a first sliding portion is disposed on an inner wall that is of the shielding cavity and that faces the first dielectric sheet, a second sliding portion is disposed on a side that is of the first dielectric sheet and that is opposite to the phase-shifting stripline, and the second sliding portion of the first dielectric sheet is slidably connected to the first sliding portion.

19. The base station antenna according to claim 18, wherein the phase shifter further comprises a third rolling ball, a fifth sliding slot is provided on the first sliding portion, a sixth sliding slot is provided on the second sliding portion, the third rolling ball is partially accommodated in the fifth sliding slot, the third rolling ball is partially accommodated in the sixth sliding slot, and the third rolling ball is capable of rolling relative to the guide rail.

20. The base station antenna according to claim 17, wherein a third sliding portion is provided on an inner wall that is of the shielding cavity and that faces the second dielectric sheet, a fourth sliding portion is provided on a side that is of the second dielectric sheet and that is opposite to the phase-shifting stripline, and the fourth sliding portion of the second dielectric sheet is slidably connected to the third sliding portion.
